(19) United States
(12) Patent Application Publication
(10) Pub. No.: US 2007/0179959 A1
(43) Pub. Date: Aug. 2, 2007

(54) Automatic discovery of data relationships

(75) Inventors: Ashvini Sharma, Redmond, WA (US); Donald M. Farmer, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/342,516

(22) Filed: Jan. 30, 2006

(51) Int. Cl. G06F 7/00

(52) U.S. Cl. 707/100

(57) ABSTRACT

A system that can facilitate automatic determination of relationships/patterns corresponding to data and appropriate mappings therewith is provided. One key concept is to employ idle time resources available when a computer is not being utilized to discover these relationships. In another aspect, the system can trigger relationship discovery in accordance with a predefined schedule. In other words, a user can specify when they would like the discovery to occur (e.g., time-based). The novel mapping components can employ different algorithms (e.g., heuristics, machine learning) to discover relationships between the sources and targets (e.g., destinations). When relationships and/or patterns are discovered, the system can notify a user to get confirmation that the mappings can be persisted. A tool or UI can be employed by a user to access and control flow of this information. As well, a repository (e.g., relationship repository) can be employed to store the information.

### BACKGROUND

As storage and availability of data grows, a large amount of time is spent identifying data relationships. Conventionally, this discovery of mapping relationships is oftentimes performed manually which, of course, leads to repetitive work and ultimately, wasting valuable time. One particular area where mapping is a critical is in the space of data integration. Data integration technologies facilitate providing and managing meaningful information to obtain a competitive business advantage, for example by harnessing historical data to aid future decisions.

At the core, integration technologies are systems and methods to extract, transform, and load (ETL) data. Data can be provided from myriad sources including enterprise resource planning (ERP) and customer relation management (CRM) applications as well as flat files, and spreadsheets, among others. Extraction mechanisms can retrieve data from several different sources. After data is extracted, it can be transformed into a consistent format associated with a target repository. Some data may only need to be reformatted during the transformation process. However, other data may need to be cleansed for instance of duplicates. Subsequently, data can be loaded into a data warehouse, data mart or the like where the data can be mined and otherwise analyzed to retrieve beneficial information.

More than half of an ETL process typically needs to be custom programmed for an organization. Conventionally, packages are central to such a program and represent a unit of work that can be independently retrieved, executed and/or saved. Furthermore, the package serves as a container for all other elements broadly characterized as control flow or data flow.

In accordance with the ETL process, as well as other data extraction and/or manipulation processes, discovery of data relationships is an integral part of the process. As stated, supra, conventionally, discovery of these data relationships is oftentimes manually performed thus, valuable programmer time is expended. Moreover, frequently, the same relationships will be discovered by a programmer thus, leading to even more inefficiencies through repetition. Thus, mapping between sources and targets, and creating simple calculations is a mundane task that takes an inordinate amount of time.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

As computer processors are becoming more powerful, it would be particularly useful to transfer the time that an individual conventionally spends discovering data relationships and identifying relationship criteria to the computer processor. Some mappings are straight forward, for example, a mapping of a name in a table to column in another table such as this name came from this system, column, etc. Oftentimes there are simple transformations such as first name, space, middle name, space, last name. In accordance therewith, the subject innovation, in one aspect thereof, can facilitate automating discovery of relationships associated with data and appropriate mappings therewith.

As described in detail herein, one key concept is to employ idle resources available when a computer is not being utilized to discover these relationships. In other words, the system can automatically discover a mapping function thereby reducing repetition of work while not interrupting ongoing computer processes.

Although the examples described herein are directed to a single computer, it is to be understood that the novel functionality of the innovation is not limited to a single machine but, can be employed throughout multiple machines and/or a network. For example, consider a user that has multiple machines in an office, when not utilized, the machines can automatically discover data relationships, patterns and/or mappings related to data. As well, the machine can query a user if a particular mapping is appropriate or not. Therefore, in this aspect, it will be appreciated that the user essentially becomes a “verifier” and not a “discoverer” thus saving valuable time. In still another aspect, it is to be understood that discovery can occur at a user's discretion. In other words, a user can specify when they would like the discovery to occur (e.g., time-based).

The following scenario is included to provide further perspective to the novel functionality of the innovation. As such, this scenario is not intended to limit the scope of the innovation in any way. In operation in accordance with an aspect, after a user completes a setup and installs a software application, the mapping system can ask the user for a list of domains that should be investigated whereby relationships can be discovered between the domains. It is to be understood that domains can be marked as sources, targets or both. Next, the mapping component can operate on behalf of the user in order to discover relationships during idle time or in accordance with a defined schedule. In other words, there is an unattended service that enables queuing of jobs either during idle time or during a time scheduled by a user.

After the user specifies what they would like to do, a tool (e.g., user interface (UI)) can be employed by the user to specify the domains. Next, the mapping component can employ different algorithmic methods (e.g., heuristics) to discover relationships between data located within the sources and targets (e.g., destinations).

When relationships and/or patterns are discovered, in one aspect, the system can notify a user to get confirmation that the mappings should be persisted. A tool or UI can be employed by a user to access this information. As well, a store (e.g., relationship repository) can be employed to maintain the relationship, pattern and/or mapping information. In other words, in one aspect, a database can be employed to store the discovered and/or verified relationships.

Verification can be automatic, for example, if direct relationships exist. In other aspects, heuristics and/or thresholds can be used to automatically discover relationships and/or verify discovered relationships. For example, fuzzy heuristics can be employed to automatically verify a mapping.

In yet another aspect thereof, an artificial intelligence or machine learning component is provided that employs a probabilistic and/or statistical-based analysis to infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that facilitates automatic discovery of data relationships in accordance with an aspect of the innovation.

FIG. 2 illustrates an exemplary flow chart of procedures that facilitate automatically mapping data in accordance with an aspect of the innovation.

FIG. 3 illustrates an alternative system that facilitates idle time discovery of data relationships in accordance with an aspect of the novel subject matter.

FIG. 4 illustrates an alternative system that facilitates discovery of data relationships in accordance with a defined schedule.

FIG. 5 illustrates an exemplary system that includes a relationship repository that maintains data relationship and/or mapping information in accordance with an aspect of the innovation.

FIG. 6 illustrates an exemplary logic component that facilitates automating functionality in accordance with an aspect of the novel innovation.

FIG. 7 illustrates a block diagram of a computer operable to execute the disclosed architecture.

FIG. 8 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

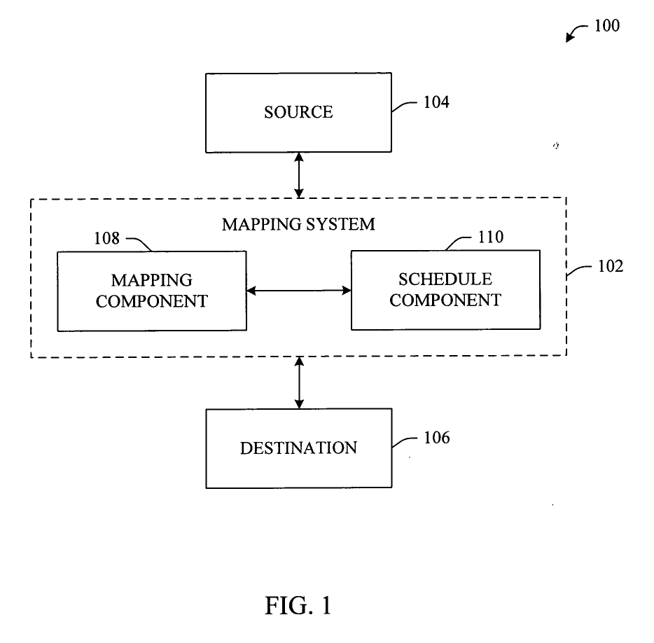

Referring initially to the drawings, FIG. 1 illustrates an architecture of a system 100 that facilitates intelligent automatic mapping between sources and targets in accordance with an aspect of the innovation. Generally, the system 100 can include a mapping system 102 that facilitates automatic and/or dynamic mapping of data relationships between a source 104 and a destination 106. As such, the innovative mapping system 102 can facilitate automatic discovery of relationships thereby alleviating the often mundane task that takes an inordinate amount of time as described above.

By way of example, sometimes as much as 70% or more of the time and effort involved in completing most data integration projects is consumed by defining and implementing the business rules by which data will be mapped, transformed, integrated, and cleansed. This simple mapping work inevitably leads to an inefficient use of programmer time. In accordance therewith, the subject mapping system 102 can include a mapping component 108 and a schedule component 110. In operation, while the mapping component 108 can facilitate automatically analyzing data in both the source 104 and destination 106, it will be understood upon a review of the figures that follow that the scheduling component 110 can effectuate timing of the automatic and/or dynamic discovery. For example, in one aspect, the scheduling component 110 can employ idle time to discover the relationship(s). In another alternative aspect, the scheduling component 110 can prompt discovery of relationships in accordance with a user preference.

Although the system architecture 100 shown in FIG. 1 includes a single source 104 and a single destination 106, it is to be understood and appreciated that the novel functionality of the mapping system 102 can be employed with any number of source and/or destination components. Further, it will be understood that it is not a prerequisite of the system for any or all of the source and/or destination components to be co-located with the mapping system 102. In other words, it is to be understood and appreciated that all or a subset of the source and/or destination components can be remotely located and accessed therefrom by the mapping component 102.

While the novel mapping system 102 facilitates efficiency improvements via automatic and/or dynamic mapping of data relationships, it will be appreciated that these redundancy and inefficiency issues show up in many different guises. For example, one of the most obvious instances shows up as a requirement of rigid mapping in an Import/Export Wizard or the designer. It will be understood that the Import/Export Wizard can be described as a utility that assists a user in defining a process for moving data between different data stores. As such, sometimes this inefficiency situation is made obvious when a programmer reviews large data warehouse loads of fact tables where the same pattern of lookup-error-create surrogate-repeat is implemented over and over again. In addition to real time savings, frustration is also alleviated by automatically discovering the data relationships on the programmer's behalf.

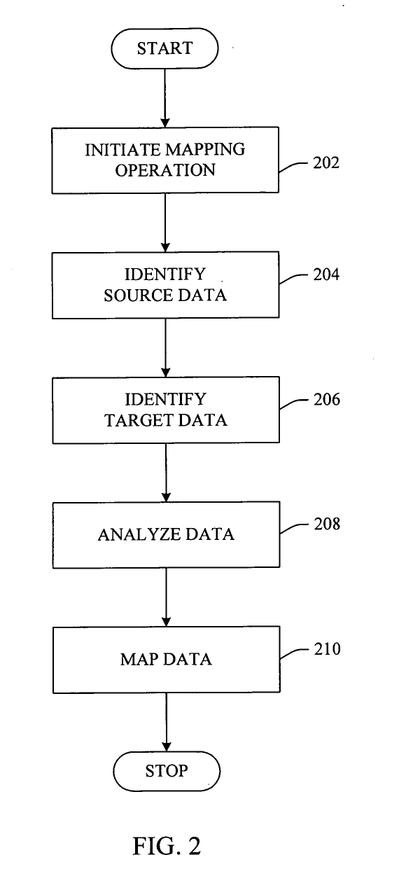

FIG. 2 illustrates a methodology of automatically mapping data in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a mapping operation is initiated. As will be better understood upon a review of the figures that follow, in one aspect, the mapping operation can be initiated by detecting and/or inferring idle time. In another aspect, the mapping operation can be scheduled either by a user or by an application. In other words, a user can proactively set a mapping schedule in order to initiate the automatic mapping operation.

At 204, source data can be identified and, at 206, target data can be identified. It is to be understood and appreciated that the source and target data can be located at any physical location or store. As well, source and target data can be co-located within the same physical location or store.

At 208, the data can be analyzed in order to discover relationships between data elements. It will be understood that any number of mechanisms can be employed in order to discover the relationships. In one aspect, heuristics can be employed to discover relationships between source and target data. In another aspect, simple comparisons can be employed to discover relationships. Once relationships are determined, data can be mapped at 210.

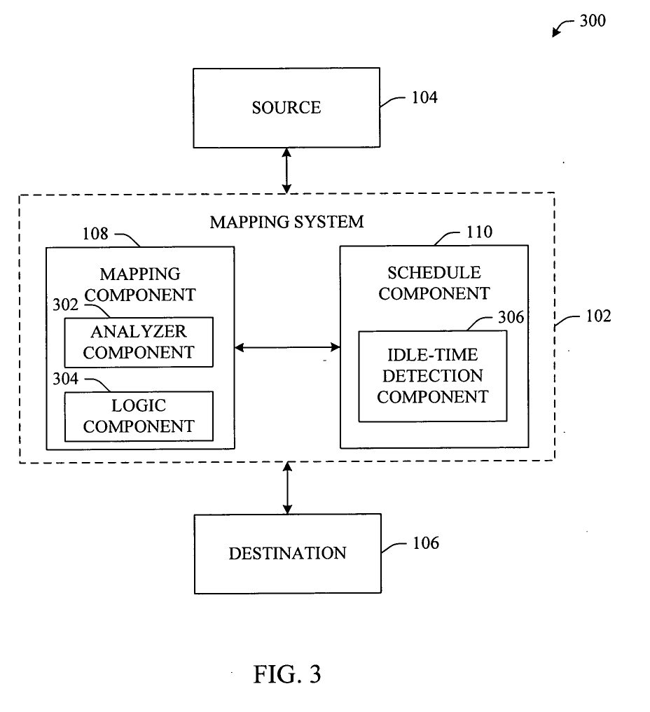

With reference now to FIG. 3, an alternative system 300 is shown in accordance with an aspect of the innovation. As shown in FIG. 3, mapping component 108 can include an analyzer component 302 and a logic component 304. In operation, the analyzer component 302 can employ the logic component 304 in order to discover data relationships. Thus, the mapping component 108 can map data based upon any desired logic. In one aspect, simple comparisons can be employed. In other aspects, rules-based logic and/or machine learning heuristics can be employed to discover patterns and relationships between data.

With continued reference to FIG. 3, in one aspect, the schedule component 110 can include an idle-time detection component 306 that can detect idle time with respect to a host system. By way of example, the idle-time detection component 306 can trigger relationship discovery upon entry into standby mode, lack of key depression or lack of movement of a pointing device. Once idle time is detected, the mapping component 108 can commence discovery of relationships and/or mapping of the data. Although this exemplary aspect is directed toward an idle time discovery system, it will be appreciated that the schedule component 110 can employ a user-defined and/or application-defined schedule by which mapping can be initiated.

By way of further example, and not limitation, given an understanding of a typical design, following are a number of exemplary opportunities that highlight potential productivity boosts in accordance with the novel automatic discovery of data relationships via mapping system 102. First, the system can automatically discover (via analyzer component 302 and logic component 304) simple column to column mappings between source and target tables. For example, the novel mapping system 102 (e.g., via mapping component 106) can detect simple arithmetic calculations such as ‘Profit=Sales−Cost’ and ‘Tax=Sales*taxRate’; or the creation of Year/Month/Day columns from a date/time column. As well, the logic component 304 can facilitate discovery of simple data type conversions, for example from string to integer.

In still other aspects, the mapping component 108 can automatically detect dimension tables and dimension keys as well as business keys and surrogate keys in a dimension. For fact table loads, the mapping component 108 can automatically identify the dimension keys and generate the lookups required for dimension keys thereafter effectuating the mapping. In yet another aspect, the mapping component 108 can automatically generate primary/foreign keys in the database and support ‘Add Related’ even if the underlying database does not have such relationships. Moreover, the logic component 304 can understand and/or infer relationships between keys and thereafter imply an order for loading data, thus mappings can be automatically discovered.

In a report designer environment, the mapping component 108 can allow users to drag and drop columns from a set of tables and automatically generate the minimal spanning query required to materialize a result. Aggregation tables and the aggregations required to populate them can also be automatically generated via the mapping system 102. The mapping system 102 can facilitate discovery of redundancy across databases which can be particularly useful for users interested in consolidating databases due to compliance requirements including, but not limited to, Sarbanes Oxley (SOX).

As described supra, it is to be understood that the novel functionality of the innovation can be employed to discover simple metadata-based matching of columns as well as patterns detected by comparing data throughout the databases. It will be understood that the aforementioned list is not intended to be exhaustive but rather a short list of incremental boosts in productivity in accordance with the novel subject innovation.

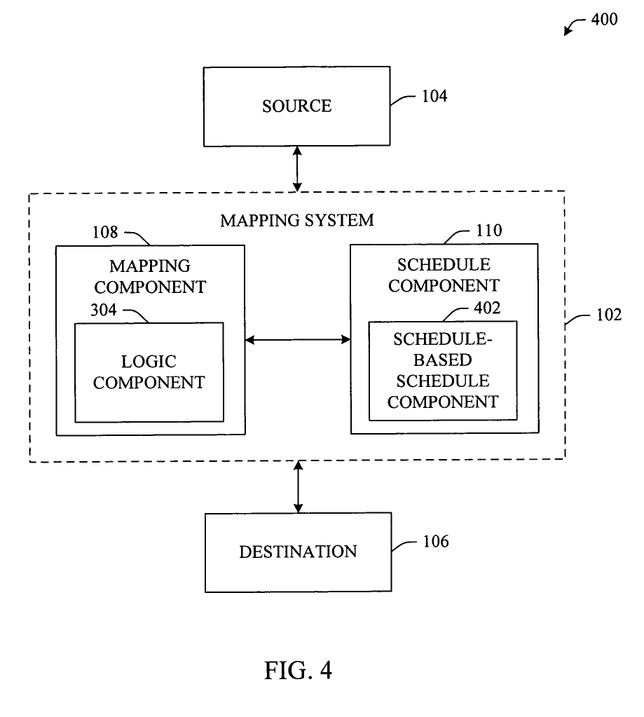

Still another alternative system 400 of the innovation is shown in FIG. 4. More particularly, FIG. 4 illustrates that the schedule component 110 can include a schedule-based schedule component 402 that triggers discovery of data relationships. In operation, the schedule component 110 can employ the schedule-based schedule component 402 to automatically initiate the discovery of data relationships via the mapping component 108.

In specific examples, the mapping system 102 can be triggered at a particular time or upon an occurrence of a specific event via schedule-based schedule component 402. By way of further example, the schedule component 110 can include a schedule-based schedule component 402 that triggers data relationship discovery at a certain time of day. In another aspect, the schedule-based schedule component 402 can employ machine learning mechanisms whereby the schedule component 110 can infer idle time and thereafter generate a schedule-based schedule component 402 in accordance with the inference.

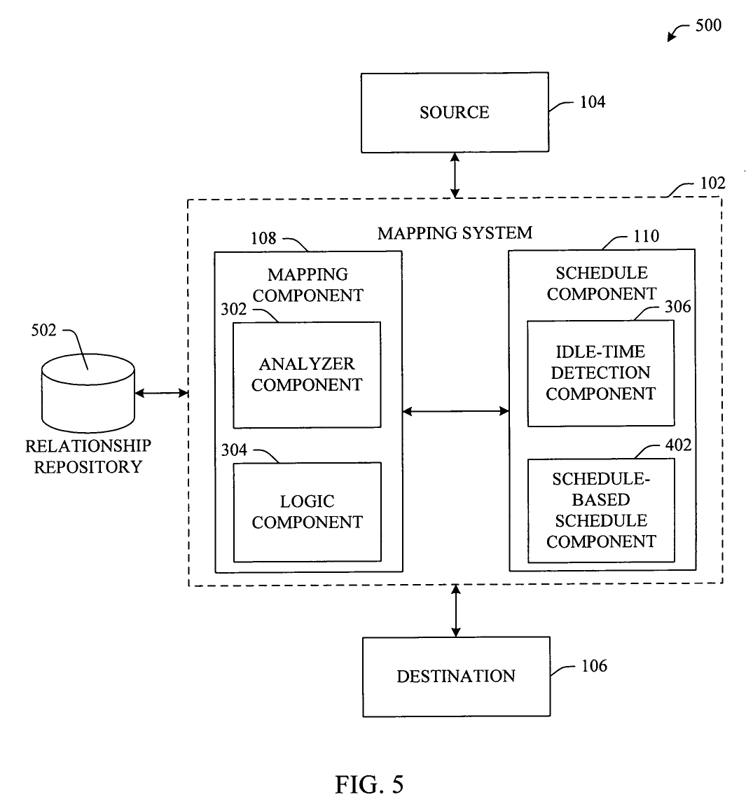

With reference to FIG. 5, an alternative system 500 is shown in accordance with an aspect of the innovation. In one aspect, the architecture of the system 500 can include a schedule component 110 that enables queuing of data discovery actions. As such, the mapping system 102 can run the actions during idle time or on a schedule specified by the user as set forth via idle time detection component 306 and schedule-based schedule component 402 described supra. This queue of data discovery actions can be maintained within a relationship repository 502.

As shown in FIG. 5, the mapping system 102 can also communicate with the relationship repository 502 in order to track and/or determine if mappings exist for specified data (e.g., columns). It will be understood that the relationship repository 502 can be remotely or co-located with respect to the mapping system 102. Moreover, it will be understood that, although the relationship repository 502 is illustrated as a single component, it will be understood that the relationship repository 502 illustrated in FIG. 5 can be representative of a plurality of remote or co-located stores.

In operation, the mapping system 102 can populate the relationship repository 502 with automatically discovered as well as customized mappings generated by users via mapping tools such as mapping wizards and editors. One particularly useful aspect of the relationship repository 502 is that it can facilitate tracking of mappings, relationships and patterns related to data thus minimizing repetition. The discovered (and/or user generated) mappings can be persisted into the relationship repository 502. The analyzer component 302 can facilitate a feedback mechanism both from users to verify the mappings created, and from tools where users explicitly create mappings that are then stored in the relationship repository 502.

In accordance with the novel functionality of the innovation described herein, a novel user interface (UI) (not shown) can be provided that enables users to perform administration of the work queue, for example, delete jobs, restart jobs, etc. The UI can also allow users to specify the source and target domains as well as to identify which files/databases are sources and which are targets. In other words, the novel UI can enable a user to monitor and/or control operation of the mapping system 102 thus enabling a user to manually generate relationships and/or verify automatically discovered relationships.

In one particular aspect, the novel UI can allow for manual specification of relationships between columns to assist the mapping component thereby further expediting the process of discovering relationships. Moreover, the novel UI can provide mechanisms for a user to inspect discovery rules and relationships thereby enabling verification and/or rejection as appropriate.

As described supra, a logic component 304 can be provided which further assists in the discovery and subsequent mapping of relationships. Although specific heuristics are described herein, it is to be understood that any logic, reasoning and/or machine learning known in the art can be employed to further compliment the novel functionality disclosed and claimed herein. These additional logic and/or reasoning mechanisms are to be included within the scope of this disclosure and claims appended hereto.

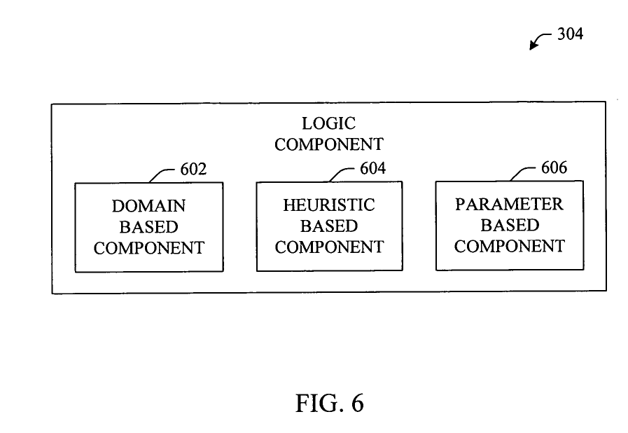

In accordance with a particular aspect, FIG. 6 illustrates a block diagram of a logic component 304 that can be employed in connection with the intelligent data relationship discovery and/or mapping process. As illustrated in FIG. 6, several categories of heuristics can be employed, for example, domain-based 602, heuristic-based 604 and parameter-based 606, some of which are more exact than others. It will be appreciated that this exemplary list of logic sub-components can also be extensible by independent software vendors (ISVs) and users to enable them to add domain specific intelligence.

In accordance with one aspect, the logic component 304 can aid in the discovery of existing schema relationships using database metadata. By way of example, simple column mapping can be employed to discover data relationships. In accordance therewith metadata-based mapping can be used which is based upon column names to identify mapping candidates. This metadata-based matching can include an ISV and/or user extensible list of common prefixes, suffices, abbreviations. By way of example, in accordance with a list of common preferences, the system can facilitate mapping column ‘FlightNbr’ to ‘Flight Number’. It is to be understood that this also includes flexible white-space handling.

In another simple column matching system, statistical matching can be employed. In other words, the logic component 304 can calculate statistics about data in a column such as minimum/maximum/median/standard deviation. In accordance therewith, this information can be employed to identify potential matches.

In another example, the logic component 304 can facilitate data warehouse specific discovery. For example, the novel innovation can facilitate identification of dimensions and fact tables, identification of dimension keys in fact tables and identification of surrogate keys in dimension tables. It will be appreciated that these identifications can be effectuated using both metadata (e.g., identity columns), statistical and historical methods. Further, identification of aggregation tables based on column names matches and results of simple group by queries sent to the source system can be employed to facilitate relationship discovery.

In still another aspect, the novel innovation can facilitate runtime discovery of data relationships. This runtime discovery could include sources such as lineage derivation during execution which can be used to create mappings as well. One advantage of these would be for those packages generated programmatically or through other tools which do not advertise their mappings to the service.

As stated above, these particular discovery scenarios are provided to add context to the innovation and are not intended to limit the innovation in any way. It is to be understood that other discovery methods exist. These additional discovery methods are to be considered within the scope of this disclosure and claims appended hereto.

As described in greater detail above, mapping data is an intensive and laborious activity typically done through a user's knowledge of existing mapping between datasets or design time support that tools provide. In either approach, a user would conventionally have to tell the system about the data mappings that exist between data sets explicitly. As described in detail above, the subject innovation enables the discovery of relationships between data elements with minimal user intervention. In disparate examples, this discovery can, for example, be performed during idle time (e.g., during the night when the machine is not utilized), or on a schedule specified by the user or application.

Although the exemplary scenarios described above are primarily directed to mappings with respect to databases, it will be appreciated that novel functionality described here can also be employed in connection with any stores of information that have metadata and a way to access the data. By way of example and not limitation, the subject novel functionality can be employed in connection with spreadsheets, flat files, XML files, etc., all of which are to be considered within the scope of this disclosure and claims appended hereto.

Referring again to FIG. 6, exemplary sub-components to the logic component 304 are shown. As illustrated, the types of the sub-components can vary on three dimensions: Domains 602, Heuristics 604 and Parameters 606. Each dimension itself can have sub-types which will be described in greater detail below.

Beginning initially with the domain-based component 602, this component can include a set based (e.g., union, merge, join), a simple mapping (e.g., source to destination) and/or a transformation sub-component (e.g., simple transformations such as first name, space, middle name, space, last name). The details of each of these logic sub-components will be understood by those skilled in the art.

In accordance with an aspect, the heuristic-based component 604 can employ similarity/dissimilarity, business domain expertise, technical domain expertise and experience in accordance with an aspect of the innovation. More particularly, the heuristic-based component 604 can determine how similar candidates are with respect to each other. This information can be employed to determine if a relationship exists.

In another aspect, the heuristic-based component can employ business domain expertise in order to facilitate discovery of a data relationship. By way of example, knowledge of a particular business area (e.g., grocery stores) can lend specific knowledge that can be leveraged into relationship discovery. Similarly, technical domain experience can be employed to assist in relationship discovery. For example, knowledge about how to handle slow changing dimensions can be leveraged to effectively discover relationships.

In still another example, artificial intelligence (AI) or machine learning can be employed to assist in relationship discovery. In one example, the system can employ historical and/or statistical knowledge in order to infer or predict a user action. Accordingly, AI can facilitate automating one or more features in accordance with the subject innovation.

More particularly, the subject innovation (e.g., in connection with relationship discovery) can employ various AI-based schemes for carrying out various aspects thereof. For example, a process for determining when to map a relationship can be facilitated via an automatic classifier system and process.

A classifier is a function that maps an input attribute vector, x=(x1, x2, x3, x4, xn), to a confidence that the input belongs to a class, that is, f(x)= confidence(class). Such classification can employ a probabilistic and/or statistical-based analysis (e.g., factoring into the analysis utilities and costs) to infer an action that a user desires to be automatically performed. In the case of database systems, for example, attributes can be words or phrases or other data-specific attributes derived from the words (e.g., database tables, the presence of key terms), and the classes can be categories or areas of interest.

A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be used to automatically learn and perform a number of functions, including but not limited to determining according to a predetermined criteria data relationship/pattern discovery, when to map a relationship, where to look for a mapping candidate, etc.

With continued reference to FIG. 6, the logic component 304 can further include a parameter-based component 606. In operation the parameter-based component can employ criteria such as business metadata (e.g., column names), technical metadata (e.g., whether a column is identity or not) or the like to facilitate relationship discovery.

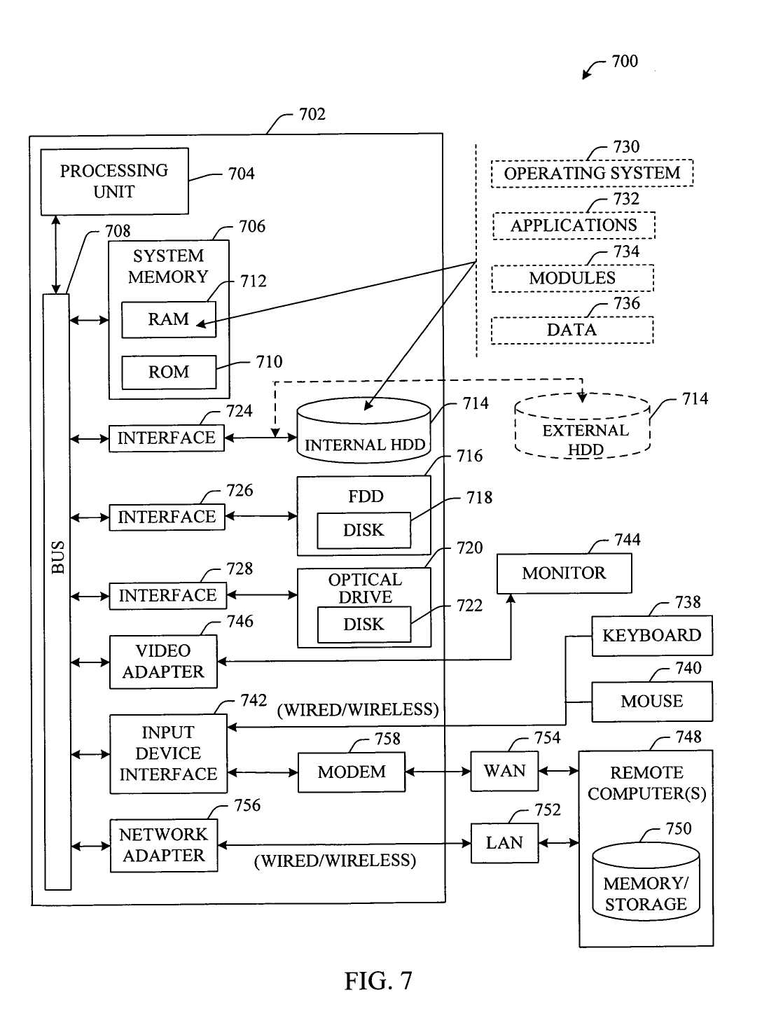

Referring now to FIG. 7, there is illustrated a block diagram of a computer operable to execute the disclosed architecture of automatically discovering data relationships and/or patterns. In order to provide additional context for various aspects of the subject innovation, FIG. 7 and the following discussion are intended to provide a brief, general description of a suitable computing environment 700 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 7, the exemplary environment 700 for implementing various aspects of the innovation includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the innovation can be implemented with various commercially available operating systems or combinations of operating systems.

A user can enter commands and information into the computer 702 through one or more wired/wireless input devices, e.g., a keyboard 738 pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

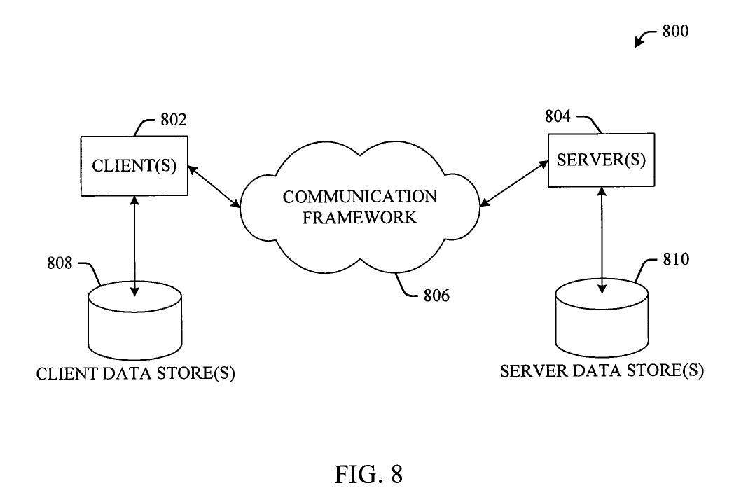

Referring now to FIG. 8, there is illustrated a schematic block diagram of an exemplary computing environment 800 in accordance with the subject innovation. The system 800 includes one or more client(s) 802. The client(s) 802 can be hardware and/or software (e.g., threads, processes, computing devices). The client(s) 802 can house cookie(s) and/or associated contextual information by employing the innovation, for example.

The system 800 also includes one or more server(s) 804. The server(s) 804 can also be hardware and/or software (e.g., threads, processes, computing devices). The servers 804 can house threads to perform transformations by employing the innovation, for example. One possible communication between a client 802 and a server 804 can be in the form of a data packet adapted to be transmitted between two or more computer processes. The data packet may include a cookie and/or associated contextual information, for example. The system 800 includes a communication framework 806 (e.g., a global communication network such as the Internet) that can be employed to facilitate communications between the client(s) 802 and the server(s) 804.

Communications can be facilitated via a wired (including optical fiber) and/or wireless technology. The client(s) 802 are operatively connected to one or more client data store(s) 808 that can be employed to store information local to the client(s) 802 (e.g., cookie(s) and/or associated contextual information). Similarly, the server(s) 804 are operatively connected to one or more server data store(s) 810 that can be employed to store information local to the servers 804.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” used in either the detailed description or the claims, such term is intended to be inclusive in a manner similar to the term “comprising” as “comprising” interpreted when employed as a transitional word in a claim.

What is claimed is:

1. A system that facilitates data mapping between a source and a target, comprising:
a schedule component that generates a trigger; and
a mapping component that, upon receipt of the trigger, automatically discovers a plurality of data relationships between the source and the target.

2. The system of claim 1, the trigger is based upon an idle time determination.

3. The system of claim 1, the schedule component includes an idle-time detection component that identifies an idle time situation and generates the trigger based upon the discovery of the idle time situation.

4. The system of claim 1, the trigger is based at least upon a time-based program.

5. The system of claim 1, the schedule component predicts an idle time and schedules the trigger based at least in part upon the prediction.

6. The system of claim 1, the mapping component comprises an analyzer component that discovers data relationships between the source and the target based at least in part upon a pre-defined logic.

7. The system of claim 6, the mapping component further comprises a logic component that facilitates the pre-defined logic based at least in part upon one of a domain-based logic, a heuristic-based logic and a parameter-based logic.

8. The system of claim 6, further comprising a heuristic component that employs a statistical-based analysis to infer an action that a user desires to be automatically performed.

9. The system of claim 6, further comprising a heuristic component that employs a historical-based analysis to infer an action that a user desires to be automatically performed.

10. The system of claim 1, further comprising a user interface that facilitates identification of the source and the target and verification of a subset of the plurality of the data relationships.

11. A computer-implemented method of automatically discovering data relationships, comprising:
initiating a mapping operation;
identifying an original data source that has a plurality of source data elements maintained therein;
identifying a target data source that has a plurality of target data elements maintained therein;
analyzing a subset of the plurality of source data elements with respect to the plurality of target data elements; and
discovering a plurality of data relationships based at least in part upon a result of the act of analyzing.

12. The computer-implemented method of claim 11, further comprising detecting an idle time situation and initiating the mapping operation based at least in part upon the idle time situation.

13. The computer-implemented method of claim 11, further comprising establishing a time-based program and initiating the mapping operation based at least in part upon the time-based program.

14. The computer-implemented method of claim 11, further comprising inferring an idle time situation and initiating the mapping operation based at least in part upon the idle time situation.

15. The computer-implemented method of claim 11, the act of discovering further comprises employing heuristics to infer a subset of the plurality of the data relationships.

16. The computer-implemented method of claim 11, further comprising verifying a subset of the data relationships.

17. The computer-implemented method of claim 16, further comprising mapping a subset of the plurality of source data elements to a plurality of target data elements based at least in part upon the verification.

18. A computer-executable system that facilitates data relationship discovery, comprising:
means for detecting an idle time related to a source and a target;
means for automatically determining a plurality of data relationships between the source and the target; and
means for mapping a subset of the plurality of data relationships between the source and the target.

19. The computer-executable system of claim 18, further comprising means for identifying the source and the target.

20. The computer-executable system of claim 19, further comprising means for verifying the subset of the plurality of data relationships.
